(19) United States
(12) Patent Application Publication
(10) Pub. No.: US 2011/0110095 A1
(43) Pub. Date: May 12, 2011

(54) SOLID-STATE LAMPS WITH PASSIVE COOLING

(75) Inventors: Yi-Qun Li, Danville, CA (US); Haitao Yang, San Jose, CA (US)

(73) Assignee: INTEMATIX CORPORATION, Fremont, CA (US)

(21) Appl. No.: 12/898,470

(22) Filed: Oct. 5, 2010

Related U.S. Application Data
(60) Provisional application No. 61/250,148, filed on Oct. 9, 2009.

(51) Int. Cl. F21V 29/00

(52) U.S. Cl. 362/294

(57) ABSTRACT

A solid-state lamp comprises a body having a first chamber with inlet apertures and a second chamber with outlet apertures. The chambers are interconnected in fluid communication by one or more passages. The lamp further comprises a thermally conductive substrate having a heat radiating surface located within at least one chamber and one or more solid-state light emitters, typically LEDs, mounted in thermal communication with the thermally conductive substrate. The lamp is configured such that in operation heat generated by the LEDs is radiated by the substrate into one or both chambers causing a difference in air pressure between the chambers that results in surrounding air being drawn into the inlet apertures, flowing through the chambers via the interconnecting passages in the substrate and exiting through the outlet apertures thereby cooling the substrate and LEDs.

### CROSS REFERENCE TO RELATED APPLICATION

This application claims the benefit of priority to U.S. Provisional Patent Application No. 61/250,148 entitled “Solid-State Lamps with Passive Cooling” by Yi-Qun Li et al., filed Oct. 9, 2009, the specification and drawings of which are incorporated herein by reference.

### BACKGROUND OF THE INVENTION

1. Field of the Invention

This invention relates to solid-state lamps with passive cooling and in particular to lamps based on LEDs (Light Emitting Diodes). More particularly, although not exclusively, the invention concerns solid-state reflector-type lamps with improved passive cooling arrangements.

2. Description of the Related Art

White light generating LEDs, “white LEDs”, are a relatively recent innovation and offer the potential for a whole new generation of energy efficient lighting systems to come into existence. It is predicted that white LEDs could replace filament (incandescent), fluorescent and compact fluorescent light sources due to their long operating lifetimes, potentially many hundreds of thousands of hours, and their high efficiency in terms of low power consumption. It was not until LEDs emitting in the blue/ultraviolet part of the electromagnetic spectrum were developed that it became practical to develop white light sources based on LEDs. As taught, for example in U.S. Pat. No. 5,998,925, white LEDs include one or more phosphor materials, that is photo-luminescent materials, which absorb a portion of the radiation emitted by the LED and re-emit radiation of a different color (wavelength). Typically, the LED chip or die generates blue light and the phosphor(s) absorbs a percentage of the blue light and re-emits yellow light or a combination of green and red light, green and yellow light or yellow and red light. The portion of the blue light generated by the LED that is not absorbed by the phosphor is combined with the light emitted by the phosphor to provide light which appears to the eye as being nearly white in color.

To date high brightness white LEDs have been used to replace conventional incandescent light bulbs, halogen reflector lamps and fluorescent lamps. Most lamps utilizing LEDs comprise arrangements in which a plurality of LEDs replaces the conventional light source component. For example it is known to replace the filament assembly of an incandescent light bulb with white LEDs or groups of red, green and blue emitting LEDs. WO 2006/104553 teaches such an LED light bulb in which a plurality of white LEDs is mounted on a front face, back face and top edge of a generally rectangular substrate (printed circuit board) such that their combined light emission is generally spherical and replicates the light output of a conventional incandescent light bulb. The substrate is enclosed in a light transmissive cover and mounted to a connector base (e.g. screw cap) for coupling the bulb to a power source. U.S. Pat. No. 6,220,722 and U.S. Pat. No. 6,793,374 disclose LED lamps (bulbs) in which groups of white LEDs are mounted on the planar faces of a polyhedral support having at least four faces (e.g. cubic or tetrahedral). The polyhedral support is connected to a connector base by a heat dissipating column. The whole assembly is enclosed within a transparent bulb (envelope) such that it resembles a conventional incandescent light bulb.

A problem that needs addressing in the development of solid-state lamps, in particular compact lamps that can be used as direct replacements for incandescent light bulbs and reflector lamps is adequately dissipating the heat generated by the large number of LEDs required in such lamps and thereby preventing overheating of the LEDs. Various solutions have been proposed. One solution is to mount the LEDs on a heat sink which comprises the body of the lamp in which the heat sink is mounted to a conventional connector cap enabling the lamp to be used in a conventional lighting socket. As for example is described in U.S. Pat. No. 6,982,518 the heat sink can include a plurality of latitudinal fins to increase its heat radiating surface area. A transparent or translucent domed cover can be provided over the LEDs such that the device bears a resemblance to a conventional light bulb. In U.S. Pat. No. 6,982,518 the form factor of the heat sink is shaped to substantially mimic the outer surface profile of an incandescent light bulb.

In U.S. Pat. No. 6,793,374, to aid in the dissipation of heat, the heat dissipating column can: include a heat sink; include inlet and outlet apertures for aiding air flow within the envelope; be in thermal communication with the cap; or include a fan to generate a flow of air in the lamp.

CA 2 478 001 discloses an LED light bulb in which the LEDs are mounted on a thermally conductive cylindrical core assembly. The core assembly is a segmented structure and comprises a stack of three different discs mounted on a rod. The LEDs are connected to circuit disks that are interposed between insulator discs and metallic discs. The core assembly is enclosed within a light diffusing cover that includes an opening in its base and an impeller for creating a uniform turbulent flow of air over the core and out of holes in a cap.

WO 2007/130359 proposes completely or partially filling the shell (envelope) of an LED bulb with a thermally conductive fluid such as water, a mineral oil or a gel. The thermally conductive fluid transfers heat generated by the LEDs to the shell where it is dissipated through radiation and convection as in an incandescent light bulb. Similarly, WO 2007/130358 proposes filling the envelope with a thermally conductive plastic material such as a gel or liquid plastics material.

U.S. Pat. No. 7,144,135 teach an LED lamp comprising an exterior shell that has the same form factor as a conventional incandescent PAR (parabolic aluminized reflector) type lamp. The lamp includes an optical reflector that is disposed within the shell and directs the light emitted by one or more LEDs. The optical reflector and shell define a space that is used to channel air to cool the lamp and the LEDs are mounted on a heat sink that is disposed within the space between the shell and the reflector. The shell includes one or more apertures that serve as air inlet and exhaust apertures and a fan is provided within the space to move air over the heat sink and out of the exhaust apertures. Whilst such an arrangement may improve cooling the inclusion of a fan can make it too noisy or expensive for many applications and also less energy efficient due to the electrical power requirement of the fan.

The present embodiments arose in an endeavor to provide a solid-state reflector lamp which at least in part overcomes the limitations of the known arrangements and in particular, although not exclusively, provides improved cooling.

### SUMMARY OF THE INVENTION

Embodiments of the invention are directed to solid-state lamps in which heat generated by the one or more solid-state light emitters, typically LEDs, is used to generate a difference in air pressure between interconnected air chambers within the lamp body to thereby promote a flow of air through the lamp body and provide passive cooling of the solid-state light emitter(s).

According to the invention a solid-state lamp comprises: a body with a first chamber having inlet apertures and a second chamber having outlet apertures, said chambers being interconnected in fluid communication by at least one passage; a thermally conductive substrate having a heat radiating surface located within at least one chamber; and at least one solid-state light emitter mounted in thermal communication with the thermally conductive substrate. The lamp is configured such that in operation heat generated by the one or more light emitters and radiated by the heat radiating surface of the substrate into one or both chambers causes the air pressure in one chamber to be higher than the air pressure in the other chamber. The air pressure difference between the chambers causes air surrounding the lamp to be drawn into the inlet apertures and flow through the first and second chambers via the interconnecting passage(s) and exit through the outlet apertures thereby causing passive cooling of the substrate and light emitter(s).

The air pressure within each chamber is inversely proportional to the volume of the chamber and proportional to the air temperature. The chamber with the higher air pressure can comprise the first chamber with the inlet apertures or the second chamber with the outlet apertures.

In one arrangement the thermally conductive substrate comprises heat radiating surfaces located within both chambers. For ease of fabrication the substrate preferably separates the first and second chambers and is in the form of a thermally conductive partition that includes the one or more interconnecting passages. Alternatively, the chambers can be separated by a partition which may or may not be in thermal communication with the substrate. In lamps in which the heat conductive substrate is shared between the chambers, the air temperature within each chamber will be similar and the air pressure difference between the chambers can be achieved by configuring the chambers to have different volumes.

In arrangements in which the first chamber with the inlet apertures is at a higher air pressure the heat radiating surface is preferably located within at least the first chamber. To increase the air pressure within the first chamber relative to the air pressure within the second chamber and thereby increase air flow through the lamp body, the volume of the first chamber is preferably less than the volume of the second chamber. Additionally, the total area of the outlet apertures can be greater than the total area of the inlet apertures to increase the pressure difference between the first and second chambers. To ensure that air flows from the first chamber into the second chamber rather that out of the inlet apertures, the total area of the inlet apertures is preferably less than the total area of the one or more passages interconnecting the chambers. Moreover, the total area of the outlet apertures is preferably greater than the total area of the one or more passages interconnecting the first and second chambers.

To maximize the air pressure difference between chambers substantially all of the heat radiating surface(s) of the substrate can be located within the first chamber. Alternatively the thermally conductive substrate further comprises a heat radiating surface located within the second chamber. In such an arrangement the heat radiating area of the substrate within the first chamber is preferably greater than the heat radiating surface area within the second chamber.

To further increase the radiation of heat into one or both chambers the heat radiating surface can further comprise heat radiating fins. Alternatively and/or in addition the heat radiating surface comprises a surface treatment to promote radiation of heat from the surface.

In arrangements in which the second chamber with the outlet apertures is at a higher air pressure the heat radiating surface is preferably located within at least the second chamber. To increase the air pressure within the second chamber, the volume of the second chamber is preferably less than the volume of the first chamber.

The thermally conductive substrate has a thermal conductivity that is as high as possible and is preferably at least 150 Wm⁻¹K⁻¹ and more preferably at least 200 Wm⁻¹K⁻¹. It can comprise for example copper, an alloy of copper, aluminum, anodized aluminum, an aluminum alloy, a magnesium alloy, a metal loaded plastics material or a thermally conductive ceramic such as aluminum silicon carbide (AlSiC).

The body can have a form which is generally conical; generally cylindrical; generally hemispherical; or generally spherical. In one arrangement the body comprises an exterior shell and further comprises an inner light reflective surface that together with the exterior shell at least in part defines the first and second chambers. To enable the lamp to be used directly in existing lighting fixtures (housings), the body can have a form factor that resembles a standard form such as a Parabolic Aluminized Reflector (PAR) including PAR64; PAR56; PAR38; PAR36, PAR30 or PAR20. Alternatively the body can resemble a Multifaceted Reflector (MR) lamp including MR16 or MR-11 or an envelope of an incandescent light bulb.

It is contemplated in other arrangements that the lamp comprise a series of three or more interconnected chambers.

The present invention arose in relation to a reflector lamp and according to a further aspect of the invention a solid-state reflector lamp comprises: a body comprising an exterior shell and an inner light reflective surface that together at least in part define a chamber having inlet and outlet apertures; a thermally conductive partition configured to divide the chamber into first and second chambers such that the first chamber contains the inlet apertures and the second chamber contains the outlet apertures, the partition further comprising at least one passage inter-connecting the first and second chambers; and at least one solid-state light emitter mounted in thermal communication with the thermally conductive partition. The reflector lamp is configured such that in operation heat generated by the one or more light emitters and radiated by the partition into the chambers causes a difference in air pressure between the chambers that results in a flow of air through the body thereby cooling the partition and light emitter(s).

In configurations where the temperature of the air within the two chambers is similar, the first chamber can have a volume that is smaller than the volume of the second chamber to promote a difference in air pressure between chambers. Additionally, the total area of the outlet apertures can be greater than the total area of the inlet apertures to increase a pressure difference and air flow. To increase the heat radiating surface area, the heat radiating surface of the partition can further comprise heat radiating fins or veins. Preferably the thermally conductive partition has a thermal conductivity that is at least 150 Wm⁻¹K⁻¹ and more preferably at least 200 Wm⁻¹K⁻¹.

In a preferred arrangement the exterior shell and inner light reflective surface generally comprise a frustum of a cone (i.e. a cone whose apex or vertex is truncated by a plane that is parallel to the base—frustoconical) and the light reflective surface is disposed substantially coaxially within the exterior shell. In such an arrangement the partition can be generally disc-shaped and located within the exterior shell at the truncated apex of the light reflective surface. Preferably the inner light reflective surface is generally parabolic in form and comprises a multifaceted surface. Alternatively the light reflective surface can comprise a continuous (smooth) surface. To enable the lamp to be used directly in existing lighting fixtures and/or for aesthetic considerations the exterior shell has a form factor that resembles a standard form including PAR64; PAR56; PAR38; PAR36, PAR30; and PAR20.

### BRIEF DESCRIPTION OF THE DRAWINGS

In order that the present invention is better understood solid-state lamps in accordance with the invention will now be described, by way of example only, with reference to the accompanying drawings in which:

FIG. 1 is a part sectional schematic side view of a solid-state lamp in accordance with an embodiment of the invention;

FIGS. 2a and 2b are respectively front and rear plan views of the lamp of FIG. 1;

FIG. 3 is a part sectional schematic side view of a solid-state lamp of FIG. 1 indicating air flow through the lamp;

FIG. 4 is a part sectional schematic side view of a solid-state lamp in accordance with another embodiment of the invention;

FIG. 5 is a sectional schematic of a solid-state lamp in accordance with a further embodiment of the invention; and

FIG. 6 is an exploded perspective view of the LED lamp of FIG. 5.

### DETAILED DESCRIPTION OF THE INVENTION

Throughout this specification like reference numerals are used to denote like parts.

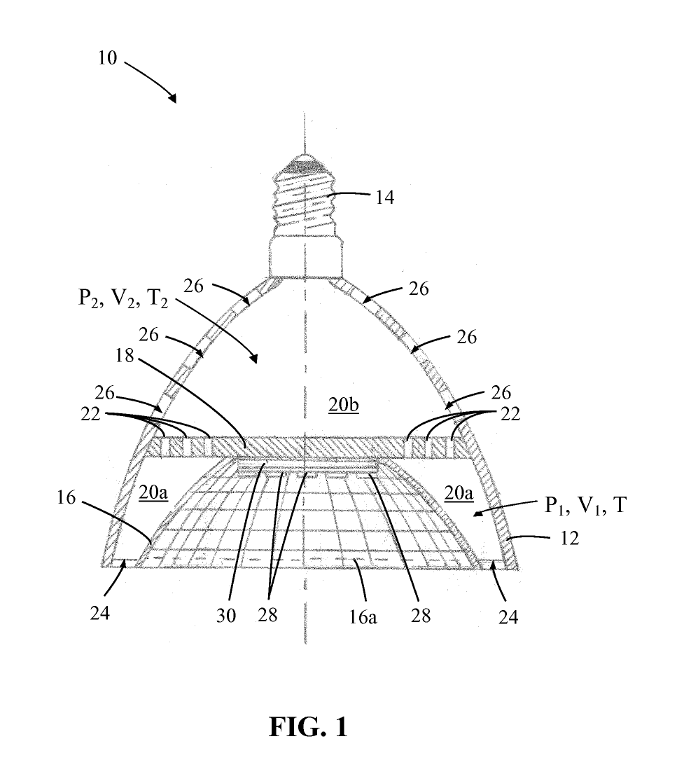

A solid-state reflector lamp 10 in accordance with an embodiment of the invention will now be described with reference to FIGS. 1, 2a, 2b and 3 of the accompanying drawings. The lamp 10 is configured for operation with a 110V (r.m.s.) AC (60 Hz) mains power supply as is found in North America and is intended for use as a direct replacement for an incandescent PAR (Parabolic Aluminized Reflector) lamp.

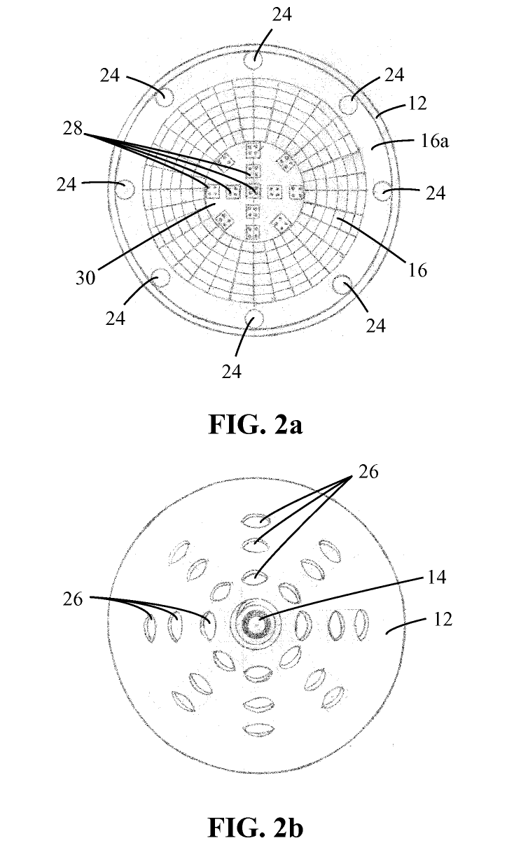

Referring to FIGS. 1, 2a and 2b the lamp 10 comprises a hollow body (shell) 12 that generally comprises a frustum of a cone; that is, a cone whose apex or vertex is truncated by a plane that is parallel to the base (substantially frustoconical). Since the lamp is intended to replace a conventional incandescent reflector lamp the body is dimensioned such as to ensure that the lamp 10 will fit directly in a conventional lighting fixture such as for example a recessed light housing. As shown the outer surface of the body 12 can be configured to have a form factor that resembles a standard reflector lamp such as a PAR 38 lamp. To aid in the dissipation of heat the body 12 can be made of a thermally conductive material such as aluminum, anodized aluminum, an alloy of aluminum, a magnesium alloy, a metal loaded plastics material such as a polymer, for example an epoxy material or polycarbonate or a thermally conductive ceramics material. For ease of fabrication the body 12 can be pressed, stamped or die cast when it comprises a metal alloy or molded when it comprises a metal loaded polymer or thermally conductive ceramic.

The lamp 10 further comprises an E26 connector cap (Edison screw lamp base) 14 mounted to the truncated apex of the body 12 enabling the lamp to be directly connected to a mains power supply using a standard electrical lighting screw socket. It will be appreciated that depending on the intended application other connector caps can be used such as, for example, a double contact bayonet connector (i.e. B22d or BC) as is commonly used in the United Kingdom, Ireland, Australia, New Zealand and various parts of the British Commonwealth, an E27 screw base (Edison screw lamp base) as used in Europe, a GU10 “turn and lock” or other connectors known in the art.

The lamp 10 further comprises a parabolic light reflector (light reflective surface) 16 that is mounted coaxially within the body 12. As shown the reflector 16 can comprise a multi-faceted surface. In other embodiments it can comprise a smooth (continuous) surface. To maximize the lamp's light emission, the light reflector 16 has as high a reflectance as possible and is typically greater than 90%. The light reflective surface can comprise a metallization layer of aluminum, silver or chromium, a white painted surface or other light reflective surfaces that will be apparent to those skilled in the art.

A thermally conductive disc-shaped partition 18 is mounted within the body 12 on the truncated apex of the reflector 16. The partition in conjunction with the body 12 and reflector 16 defines first and second chambers 20a, 20b. The first chamber 20a is of volume V₁ and comprises a generally frustoconical shell located between the body 12 and reflector 16. The second chamber 20b is of volume V₂ and comprises a generally frustoconical volume located between the connector 14 and partition 18 (i.e. in an upper portion of the body 12 as illustrated). In the embodiment illustrated the volume V₁ of the first chamber is smaller than the volume V₂ of the second chamber (Vᵢ<V₂). The thermally conductive partition 18 is fabricated from a material with a high thermal conductivity (typically ≧150 Wm⁻¹K⁻¹, preferably ≧200 Wm⁻¹K⁻¹) such as for example copper, an alloy of copper, aluminum, anodized aluminum, an aluminum alloy, a magnesium alloy, a metal loaded plastics material or a thermally conductive ceramic such as aluminum silicon carbide (AlSiC). A series of circular through holes (passages) 22 are circumferentially spaced around the peripheral edge of the partition 18 and interconnect the first and second chambers 20a, 20b to provide fluid communication between the chambers. In other embodiments the passages 22 can comprise circumferentially spaced notches (slots).

A plurality of circular inlet apertures (through holes or ports) 24 are provided on a front peripheral lip 16a of the parabolic reflector 16 and provide fluid communication to the first chamber 20a. As illustrated the inlet apertures 24 are circumferentially spaced around the lip 16a. As with the passages 22 the inlet apertures 24 can comprise a series of circumferentially spaced notches (slots).

A plurality of circular outlet apertures (through holes or ports) 26 are located towards the apex of the body 12. As illustrated the outlet apertures 26 are grouped in three sets and are circumferentially spaced around the body. Each outlet aperture extends through the entire thickness of the body 12 and provides fluid communication to the second chamber 20b. It will be appreciated that the number, size, shape and grouping of the inlet 24 and outlet 26 apertures is only exemplary and can be readily tailored by those skilled in the art for a given application. As will be further described the inlet 24 and outlet 26 apertures and passages 22 enable air to flow through the body to provide passive cooling of the lamp.

A plurality (thirteen in the example illustrated) of white light emitting LED devices 28 are mounted as a circular array on a circular MCPCB (metal core printed circuit board) 30. As is known a MCPCB comprises a layered structure composed of a metal core base, typically aluminum, a thermally conductive/electrically insulating dielectric layer and a copper circuit layer for electrically connecting electrical components in a desired circuit configuration. The metal core base of the MCPCB 30 is mounted in thermal communication with the partition 18 with the aid of a thermally conductive compound such as for example an adhesive containing a standard heat sink compound containing beryllium oxide or aluminum nitride. Rectifier or other driver circuitry (not shown) for operating the lamp 10 directly from an AC mains power supply can be housed within the connector cap 14 or within the second chamber 20b.

Each LED device 28 preferably comprises a plurality of co-packaged LED chips as for example is described in co-pending U.S. application Ser. No. 12/127,749 filed May 27, 2008, the entire content of which is incorporated herein by way of reference thereto. In the embodiment illustrated, each LED device 28 comprises a square multilayered ceramic package having a square array of four (two rows by two columns) circular recesses (blind holes) that can each house a respective LED chip. Since it is required to generate white light each recess can be potted with a phosphor (photo luminescent) material.

The phosphor material, which is typically in powder form, is mixed with a transparent binder material such as a polymer material (for example a thermally or UV curable silicone or an epoxy material) and the polymer/phosphor mixture applied to the light emitting face of each LED chip.

Optionally, the lamp 10 additionally comprises a light transmissive front cover or lens (not shown) for focusing, diffusing or otherwise directing light emitted by the lamp in a desired pattern/angular distribution.

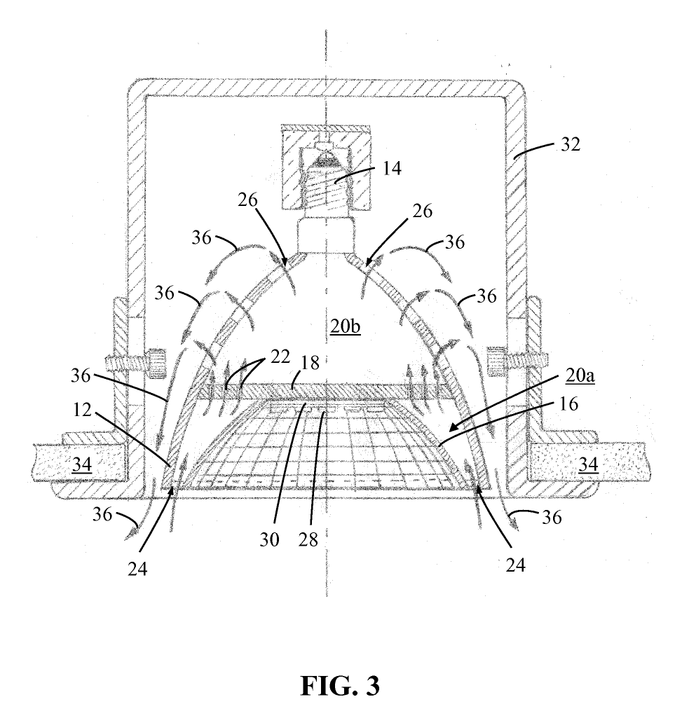

Operation of the lamp 10 will now be described with reference to FIG. 3 which shows the lamp installed in a standard recessed light housing 32. As illustrated the recessed light housing 32 is mounted in a ceiling or wall 34. In operation heat generated by the LED devices 28 is conducted into the thermally conductive partition 18 and is then conducted through the partition and then radiated from heat radiating surfaces of the partition into the first 20a and second 20b chambers. The radiated heat causes heating of the air within the first and second chambers which leads to an increase in air pressure within the chambers. Since the thermally conductive partition 18 has heat radiating surfaces located within the first and second chambers the temperature T₁, T₂ of the air within the chambers will be similar or substantially equal. However, since the volume V₁ of the first chamber is less than the volume V₂ of the second chamber, the air pressure P₁ within the first chamber will be higher than the air pressure P₂ in the second chamber 20b and the ratio of the air pressures generally given by the relationship:

P₁/P₂=V₂/V₁.

As indicated by the solid arrows 36 in FIG. 3, this air pressure difference causes air to flow from the first chamber 20a into the second chamber 20b via the passages 22 and eventually out of the lamp through the outlet apertures 26. To ensure that air flows from the first chamber into the second chamber rather than out of the inlet apertures 24, the total area of the passages 22 interconnecting the chambers is configured to be greater than the total area of the inlet apertures 24. Moreover the total surface area of the outlet apertures 26 is preferably greater than the total area of the passages 22.

In a steady state air surrounding the lamp 10 is drawn into the first chamber 20a through the inlet apertures 24, absorbs heat radiated by the partition 18 and due to the pressure difference between the chambers (P₁>P₂) is forced through the passages 22 into the second chamber 20b and is then expelled through the outlet apertures 26. This flow of air provides cooling of the partition 18 and hence cooling of the LED devices 28.

The ability of the partition 18 to dissipate heat, that is its heat sink performance, will depend on the body material, body geometry, and overall surface heat transfer coefficient. In general, the heat sink performance for a forced convection heat sink arrangement can be improved by (i) increasing the thermal conductivity of the heat sink material, (ii) increasing the surface area of the heat sink and (iii) increasing the overall area heat transfer coefficient, by for example, increasing air flow over the surface of the heat sink. In the lamp 10 of the invention the pressure difference between the first and second chambers 20a, 20b increases the overall heat transfer coefficient by increasing air flow over the partition (through the passages in the partition).

Preliminary calculations indicate that the lamp 10 of the invention could achieve an increase in heat sink performance of between 10% and 20%.

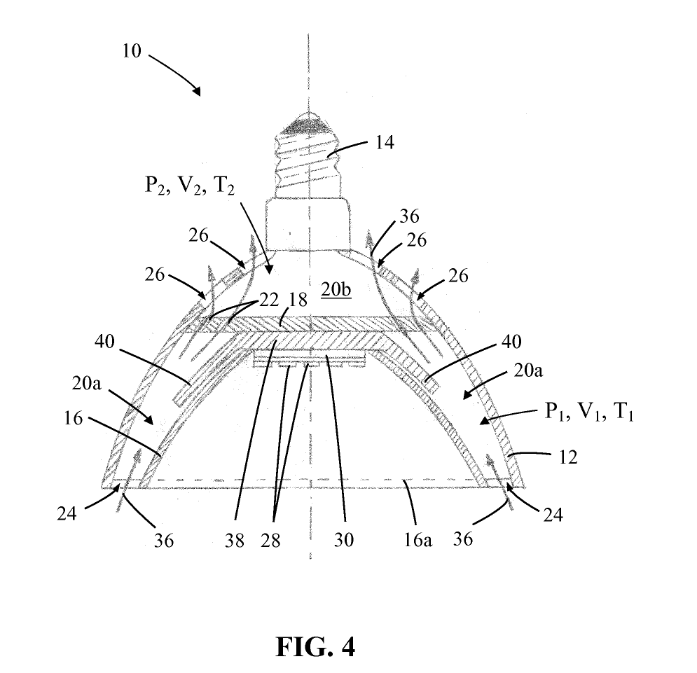

In other embodiments, and as is illustrated in FIG. 4, the LED devices 28 can be mounted on a thermally conductive substrate (heat sink) 38 and a separate partition 18 used to separate the first and second chambers 20a, 20b. In the arrangement of FIG. 4 the thermally conductive substrate 38 is in the form of a frustoconical shell with the LED devices 28 being mounted in thermal communication with the floor (truncated apex) of the substrate 38. As shown the substrate 38 can comprise a conical portion 40 that extends along the inner surface of the reflector 16 within the first chamber 20a. As shown in FIG. 4 the substrate 38 has no heat radiating surface located within the second chamber 20b. As a result the temperature T₁ of air within the first chamber 20a will be higher than the temperature T₂ of air within the second chamber 20b (T₁>T₂). This difference in air temperature can assist in increasing the air pressure P₁ within the first chamber 20a compared with the pressure P₂ within the second chamber 20b and so increase air flow through the body. The ratio of the air pressure is generally given by the relationship:

P₁/P₂=(V₂.T₁)/(V₁.T₂).

The thermally conductive substrate is fabricated from a material with a high thermal conductivity (typically ≧150 Wm⁻¹K⁻¹, preferably ≧200 Wm⁻¹K⁻¹) such as for example copper, an alloy of copper, aluminum, anodized aluminum, an aluminum alloy, a magnesium alloy, a metal loaded plastics material or a thermally conductive ceramic such as aluminum silicon carbide (AlSiC). The partition 18 can be fabricated from a thermally insulating or thermally conductive material and can be in thermal communication with the substrate.

Moreover to increase the heat radiating surface area within the first chamber 20a, the thermally conductive substrate 38 can further include a plurality of circumferentially or radially spaced heat radiating fins (veins).

Operation of the lamp 10 of FIG. 4 is analogous to that of the lamp of FIGS. 1 to 3 and is not described further.

As well as providing improved passive cooling the lamp of the invention is aesthetically more acceptable than the known lamps in which the LED devices are typically mounted flush on the base of a solid frustoconical body.

Each of the exemplary LED-lamps described have been based on white light emitting LEDs (white LEDs) in which each LED includes a phosphor material, photoluminescence material, to down convert a portion of blue light generated by the LED die into light of a different color, often yellow or green. As is known the photoluminescence generated light combined with the blue light from the LED die gives an emission product that appears white in color. Typically in a white LED the phosphor material is provided as an encapsulation over each LED die within the LED package. It is contemplated in other embodiments to provide the phosphor material remotely to, and physically separated from, the LED die to reduce the transfer of heat from the LED die to the phosphor material. The phosphor material can be provided as one or more layers on a face of a light transmissive component (window or front cover), preferably the face facing the LEDs. Alternatively the phosphor material can be incorporated within the light transmissive component such that it is homogeneously distributed throughout the volume of the component. Providing the phosphor separately to the LEDs offers a number of advantages compared with white LEDs in which the LED dies are encapsulated with the phosphor material, namely:

i) a reduction in thermal degradation of the phosphor material since the phosphor material is located remote to, that is separated from, the LED(s);

ii) a reduction in manufacturing costs since a single type of LED can be used to generate a required CCT and/or color hue of light by providing a component including the appropriate phosphor material(s); and

iii) a more consistent CCT and/or color hue since light generation (conversion) occurs over a much greater area.

The phosphor material(s), which is/are in powder form, is/are mixed in pre-selected proportions with a light transmissive polymer material such as for example a polycarbonate material, an epoxy material, an acrylic material or a thermosetting or UV curable light transmissive silicone. The weight ratio loading of phosphor mixture to silicone can typically be in a range 35 to 65 parts per 100 with the exact loading depending on the target correlated color temperature (CCT) or color hue of the device. The phosphor/polymer mixture can then extruded to form a homogeneous phosphor/polymer sheet with a uniform distribution of phosphor throughout its volume. Alternatively the phosphor/polymer mixture can be deposited as one or more layers onto a light transmissive substrate by for example spin coating or printing. As with the weight loading of the phosphor to polymer material, the thickness of the phosphor layer and/or phosphor/polymer sheet will depend on the target CCT and/or color hue of the lamp.

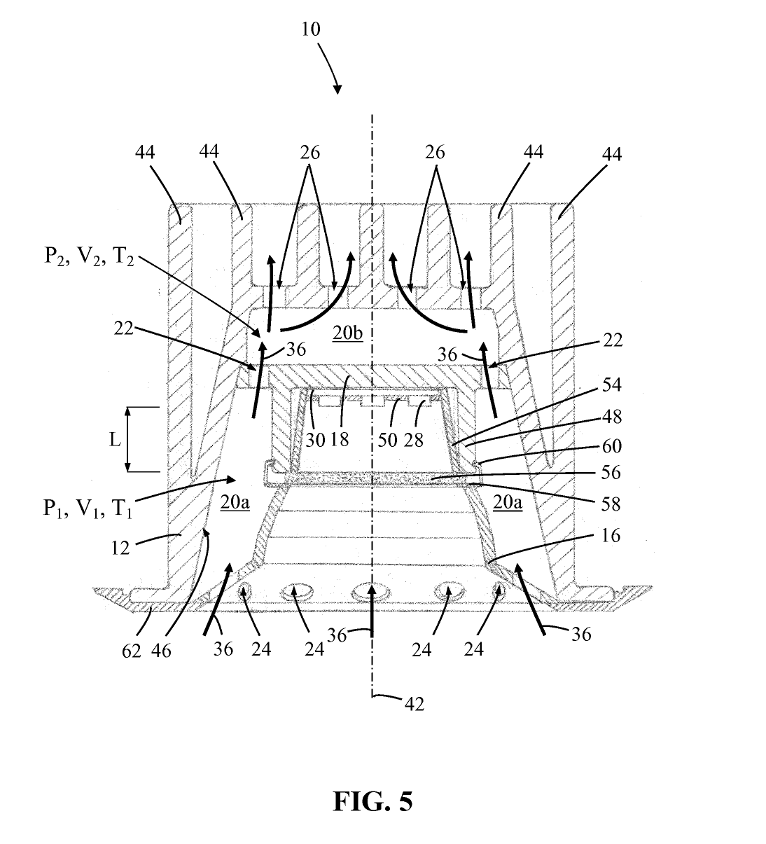

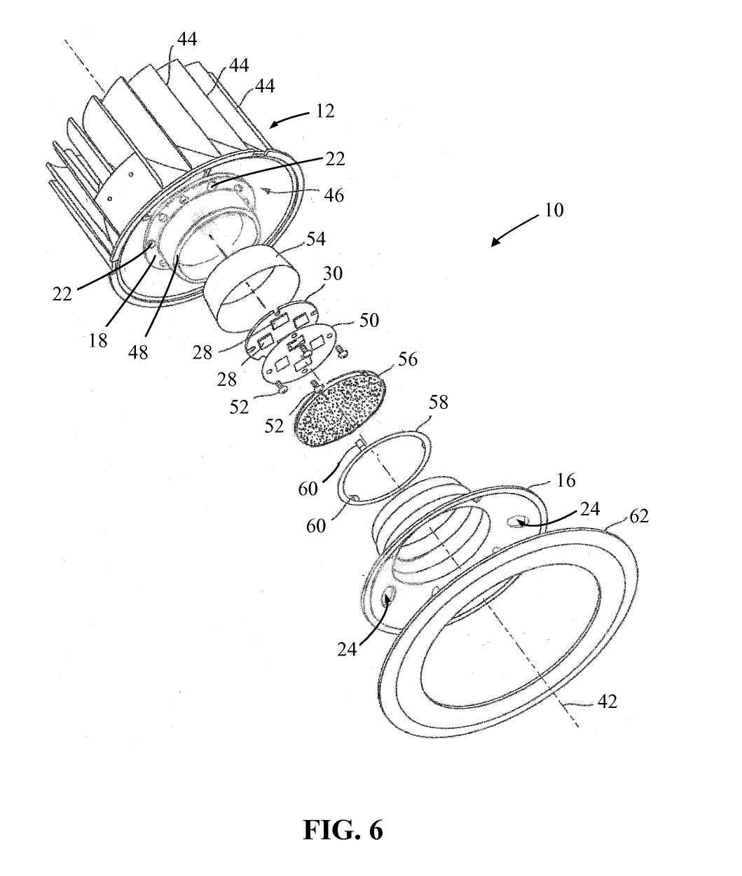

A solid-state lamp 10 in accordance with a further embodiment of the invention that utilizes a remotely located phosphor material is now described with reference to FIGS. 5 and 6 which respectively show a sectional schematic view and an exploded perspective view of the lamp. The lamp 10 is configured to generate white light with a CCT≈3000° K, an emission intensity of about 500 lumens and a selected emission angle θ≈50° (angle of divergence measured from a central axis 42). It is intended that the lamp be used as an energy efficient replacement for a six inch down light.

In this embodiment the body 12 is generally cylinder-shaped and can be fabricated from die cast aluminum, an aluminum alloy or magnesium alloy. The body 12 has a series of latitudinal spirally extending heat radiating fins 44 towards the base of the body and a generally frustoconical axial chamber 46 that extends from the front of the body a depth of approximately two thirds of the length of the body. The thermally conductive partition 18 is generally disc-shaped and has an axial hollow cylindrical chamber 48 extending from one face that is configured to house the array of LEDs. The partition 18 is mounted approximately one third of the length (axial) from the base of the chamber 46 and defines the second chamber 20b which is generally cylindrical in shape. The second chamber 20b is interconnected in fluid communication with the frustoconical chamber 46 by a plurality of circumferentially spaced through holes (passages) 22 that pass through the full thickness of the partition 18. Outlet apertures 26 interconnect the second chamber 20b to the exterior of the lamp and can as shown be configured to pass between the heat radiating fins 44. In alternative embodiments the partition 18 and cylindrical chamber 48 can be formed as an integral part of the body.

The form factor of the body 12 is configured to enable the lamp 10 to retrofitable directly in a standard six inch down lighting fixture (can) as are commonly used in the United States.

Four blue light emitting LEDs 28 are mounted as an array on a circular shaped MCPCB 30. With the aid of a thermally conductive compound the metal core base of the MCPCB 30 is mounted within the chamber 48 in thermal communication with the floor of the chamber 48 (i.e. in thermal communication with the partition 18). Each LED 28 preferably comprises a 3 W ceramic packaged array of gallium nitride-based blue LED dies (chips). To maximize the emission of light, the lamp can further a light reflective circuit mask 50 that covers the MCPCB and includes a respective opening corresponding to each LED 28. The circuit mask 50 can comprise a thin sheet of light reflective polymer material that is white or has a white finish. The MCPCB 30 and circuit mask 50 can be mechanically fixed to the base of the cavity 48 by one or more screws 52, bolts or other fasteners.

The lamp 10 further comprises a hollow generally cylindrical chamber wall mask 54 that is configured to surrounds the array of LEDs 28 and provide a light reflective surface to the inner walls of the chamber 48. The chamber wall mask 54 can be made of a plastics material and preferably has a white or other light reflective finish. In alternative arrangements the inner wall of the chamber 48 can be polished or otherwise coated to make it light reflective and the chamber wall mask dispensed with.

A light transmissive window 56 is mounted over the front of the cylindrical chamber 48 using an annular steel clip 58 that has resiliently deformable barbs 60 that engage in corresponding apertures or a groove in the outer wall of the chamber 48. The window 56 includes one or more phosphor materials. The phosphor material(s) can be incorporated within the window and homogeneously distributed throughout the volume of the window or provided as one or more layer on at least one face of the window. The window 56 can be fabricated from any light transmissive material such as for example a polycarbonate, an acrylic, a silicone material or a glass. As can be seen from FIG. 5 the light transmissive window 56, more particularly, the phosphor material(s) are physically separated from the LEDs 28 by an air gap of length L. Typically the phosphor material can be separated from the LEDs by a length L=5 mm to 25 mm.

The reflector 16 comprises a generally frustoconical shell with four contiguous (conjoint) light reflective frustoconical surfaces. The reflector 16 is preferably made of Acrylonitrile butadiene styrene (ABS) with a metallization layer. The reflector 16 in conjunction with the outer wall of the chamber 48 defines an inner wall of the first chamber 20a. The outermost frustoconical light reflective surface of the reflector 16 includes a plurality of circular inlet apertures (through holes or ports) 24 that provide fluid communication to the first chamber 20a. As illustrated the inlet apertures 24 are circumferentially spaced towards the outer edge of the reflector.

Finally the lamp 10 can comprise a decorative annular trim (bezel) 62 that can also be fabricated from ABS.

The operation of the lamp of FIGS. 5 and 6 is similar to that of the lamp of FIGS. 1 to 3 and is not described further.

It will be appreciated that the present invention is not restricted to the specific embodiments described and that variations can be made that are within the scope of the invention. For example, whilst the lamp of the invention arose in relation to a reflector-type lamp, in other embodiments the lamp can comprise other forms and resemble for example a Multifaceted Reflector (MR) lamp or an incandescent light bulb. In such arrangements the body can have a form of being generally conical; generally cylindrical; generally hemispherical; or generally spherical. To enable the lamp to be used directly in existing lighting fixtures the body can have a form factor that resembles a standard form such as a Parabolic Aluminized Reflector (PAR) including PAR64, PAR56, PAR38, PAR36, PAR30 or PAR20; a Multifaceted Reflector (MR) lamp including MR16 or MR-11 or an envelope of an incandescent light bulb.

In each of the embodiments described the air pressure P₁ within the chamber with the inlet apertures 24 is higher than the air pressure P₂ within the chamber with the outlet apertures 26. It is contemplated in other arrangements that the lamp is configured such that the opposite is true and the air pressure within the chamber with the outlet apertures is higher than the air pressure within the chamber with the inlet apertures. It will be appreciated that in such lamps the ratio of the total surface areas of the inlet apertures, outlet apertures and one or more interconnecting passages is accordingly configured to ensure a correct direction of air flow through the lamp. Moreover it is contemplated that the lamp comprises a series of three or more interconnected chambers.

It is further contemplated that the light reflector can comprise the thermally conductive substrate.

In other embodiments it is contemplated to fabricate a transmissive sheet containing phosphor material and to cut this into appropriately sized pieces and bond these onto the face on the LED device package with for example a light transmissive (transparent) adhesive such as optical quality epoxy or silicone. In such an arrangement each recess of the LED device is preferably filled with a transparent material such as to cover and encapsulate each LED die. The light transmissive encapsulation constitutes a passivation coating of the LED die thereby providing environmental protection of the LED die and bond wires. Additionally, the light transmissive material acts as a thermal barrier and reduces the transfer of heat to the overlying phosphor material layer.

Although to reduce flicker it is preferred to use a separate rectifier circuit to drive the LED devices it will be appreciated that in other implementations the plurality of LED devices can be connected in a self-rectifying configuration such as for example is described in co-pending United States Patent Application US2009/0294780 A1 filed May 27, 2008. Moreover the lamp can be driven from a DC supply.

What is claimed is:

1. A solid-state lamp comprising: a body with a first chamber having inlet apertures and a second chamber having outlet apertures, said chambers being interconnected in fluid communication by at least one passage; a thermally conductive substrate having a heat radiating surface located within at least one chamber; and at least one solid-state light emitter mounted in thermal communication with the thermally conductive substrate.

2. The lamp according to claim 1, wherein the thermally conductive substrate comprises heat radiating surfaces located within both chambers.

3. The lamp according to claim 2, wherein the substrate separates the first and second chambers.

4. The lamp according to claim 1, wherein the heat radiating surface is located within at least the first chamber.

5. The lamp according to claim 4, wherein the first chamber has a volume that is less than the volume of the second chamber.

6. The lamp according to claim 5, wherein the total area of the outlet apertures is greater than the total area of the inlet apertures.

7. The lamp according to claim 5, wherein the total area of the outlet apertures is greater than the total area of the passages interconnecting the chambers.

8. The lamp according to claim 5, wherein the total area of the inlet apertures is less than the total area of the passages interconnecting the chambers.

9. The lamp according to claim 4, wherein the heat radiating area of the substrate within the first chamber is greater than the heat radiating surface area within the second chamber.

10. The lamp according to claim 9, wherein the heat radiating surface of the substrate further comprises heat radiating fins.

11. The lamp according to claim 1, wherein the thermally conductive substrate has a thermal conductivity selected from the group consisting of being: at least 150 Wm⁻¹K⁻¹ and at least 200 Wm⁻¹K⁻¹.

12. The lamp according to claim 1, wherein the body has a form selected from the group consisting of being generally: conical; cylindrical; hemispherical; and spherical.

13. The lamp according to claim 1, wherein the body comprises an exterior shell and further comprising an inner light reflective surface that together with the shell at least in part define the first and second chambers.

14. The lamp according to claim 1, wherein the body has a form factor that resembles a standard form selected from the group consisting: PAR64; PAR56; PAR38; PAR36, PAR30; PAR20; MR16; MR-11; and an envelope of an incandescent light bulb.

15. A solid-state reflector lamp comprising: a body comprising an exterior shell and an inner light reflective surface that together at least in part define a chamber having inlet and outlet apertures; a thermally conductive partition configured to divide the chamber into first and second chambers such that the first chamber contains the inlet apertures and the second chamber contains the outlet apertures, the partition further comprising at least one passage interconnecting the first and second chambers; and at least one solid-state light emitter mounted in thermal communication with the thermally conductive partition.

16. The reflector lamp according to claim 15, wherein the first chamber has a volume that is less than the volume of the second chamber.

17. The reflector lamp according to claim 16, wherein the total area of the outlet apertures is greater than the total area of the inlet apertures.

18. The reflector lamp according to claim 15, wherein the thermally conductive partition has a thermal conductivity selected from the group consisting of being: at least 150 Wm⁻¹K⁻¹ and at least 200 Wm⁻¹K⁻¹.

19. The reflector lamp according to claim 15, wherein the exterior shell and inner light reflective surface generally comprise a frustum of a cone and wherein the light reflective surface is disposed substantially coaxially within the exterior shell.

20. The reflector lamp according to claim 19, wherein the thermally conductive partition is generally disc-shaped and located within the exterior shell at the truncated apex of the light reflective surface.

21. The reflector lamp according to claim 19, wherein the light reflective surface is generally parabolic in form.

22. The reflector lamp According to claim 21, wherein the light reflective surface is selected from the group consisting of being: multifaceted and a substantially continuous surface.

23. The reflector lamp according to claim 19, wherein the exterior shell has a form factor that resembles a standard form selected from the group consisting: PAR64; PAR56; PAR38; PAR36, PAR30; and PAR20.
